(19) United States
(12) Patent Application Publication
(10) Pub. No.: US 2009/0268099 A1
(43) Pub. Date: Oct. 29, 2009

(54) VIDEO SWITCHER AND SWITCHING OBJECT SWITCHER

(75) Inventor: Osamu Kazumi, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHTIA ELECTRIC INDUSTRIAL CO., LTD., Osaka (JP)

(21) Appl. No.: 12/093,367

(22) PCT Filed: Nov. 10, 2006
(86) PCT No.: PCT/JP2006/322469

§ 371 Date: May 12, 2008

(30) Foreign Application Priority Data
Nov. 28, 2005 (JP) 2005-341352

(51) Int. Cl. H04N 5/268

(52) U.S. Cl. 348/705; 348/E05.057

(57) ABSTRACT

A video switcher that enables to perform setting operation while checking the set values without being distracted by a display unit even during a program is provided. Knobs (21) serving as setting operation members are provided on a console (13) and are operated for changing the set values of the video effects. A display unit (17) displays the set values in accordance with the operation of the setting operation members. The display unit (17) is movable in a predetermined retraction direction in which the exposed range is reduced. The position of the display unit (17) in the retraction direction is detected. A control unit controls displaying by the display unit (17) in accordance with the detected position information and changes the display of the set values so as to display the set values on the exposed range that is remaining when the display unit (17) is shifted in the retraction direction. The control unit changes the display position of the set values on the display unit (17) in the opposite direction of the retraction direction when the display unit (17) is shifted in the retraction direction.

### TECHNICAL FIELD

The present invention relates to a video switcher capable of improving the operability.

### BACKGROUND ART

Conventionally, a video switcher called a switcher has been used for producing videos of TV programs and the like. The video switcher is used for selecting a video that should be broadcasted from videos taken by a plurality of cameras.

FIGS. 6 to 8 show a typical example of a conventional video switcher. As shown in FIG. 6, a video switcher 100 is arranged in front of a multiplicity of monitors 102 for video monitoring. FIG. 7 and FIG. 8 are plan views of the video switcher. FIG. 8 is simplified to facilitate understanding of the description. As shown in the figures, the video switcher comprises a console 104, and a button group for video switching operation is arranged on the console 104. A display unit 106 is provided at the rear edge of the console 104. In FIGS. 7 and 8, although the display unit 106 is depicted as being laid flat to facilitate understanding, the display unit 106 is actually placed upright as shown in FIG. 6. In general, the display unit 106 is constructed by a flat panel display. The display unit 106 is called a menu display panel and is used for setting details of the video effects. The video effects are registered using the display unit 106, and the video effects are invoked using the button group of the console 104.

The display unit 106 is integrated with operation members for changing the set values of the video effects. In the example of the figures, a plurality of knobs 108 are arranged as operation members at the edge of the display area. The set value of each knob 108 is displayed at the edge of the display area in the proximity to the knob 108. When the knobs 108 are rotated, the set values corresponding to the knobs 108 are changed, and the display of the set values is changed as well.

Generally, in the production of programs, detail setting with the display unit 106 is often conducted only in the preparatory stages of the programs. Often times, only the console 104 is used during the programs. Thus, conventionally, the display unit 106 is configured to be able to be shifted or housed. The display unit 106 is shifted during a program such that the monitor is easy to watch. The location of the display unit 106 may be used to place another device that is more frequently used during a program.

A conventional video switcher is disclosed, for example, in Japanese Patent Laid-Open No. 2003-8943 (page 2, FIG. 1).

In the conventional video switcher, setting operation members such as knobs 108 are integrated with the display unit 106. In addition, the display unit 106 is shifted or housed during a program. Therefore, there is a problem that a sudden request for changing the setting during a program cannot be responded quickly.

In order to solve such a problem, the knobs 108 may be separated from the display unit 106. However, when only the knobs 108 are left, the set values of operations set by the knobs 108 cannot be checked if the display unit 106 is moved. Therefore, the setting operations during a program remain difficult.

In the foregoing description, a problem in the background art of the present invention has been described in relation to the video switcher. However, a similar problem may arise in a switching apparatus that switches a switching object other than videos. A switching apparatus that switches an object other than videos is, for example, an audio switching apparatus and a lighting apparatus. The audio switching apparatus is called a mixer, which comprises a console for switching operation as does the video switcher, and is used for broadcasting, in event sites, or the like. The lighting apparatus also comprises a console for switching operation and is used for broadcasting, in event sites, or the like. Even when the switching object is different, a problem may arise that a sudden request for changing the setting cannot be quickly responded if the display unit is shifted after the preparation is completed.

### DISCLOSURE OF THE INVENTION

### Problems that the Invention is to solve

The present invention has been made to solve the conventional problem and the object thereof is to provide a video switcher that enables to perform setting operation while checking the set values without being distracted by a display unit even during a program.

### Means for solving the problems

One aspect of the present invention provides a video switcher comprising: a console operated for switching a video; a setting operation member provided on the console and operated for changing the set value of the video effect; a display unit that displays the set value corresponding to the operation of the setting operation member; a shift mechanism that shifts the display unit in a predetermined retraction direction in which the exposed range of the display unit is reduced; a display unit position detection unit that detects the position of the display unit in the retraction direction; and a control unit that controls the display of the display unit in accordance with the position information detected by the display unit position detection unit, wherein the control unit changes the display of the set value so as to display the set value on the exposed range that is remaining when the display unit is shifted in the retraction direction.

Another aspect of the present invention provides a video switcher comprising: a console operated for switching a video; a display unit that is used for setting the video effect and that displays the set value of the video effect; a shift mechanism that shifts the display unit in a predetermined retraction direction in which the exposed range of the display unit is reduced; a display unit position detection unit that detects the position of the display unit in the retraction direction; and a control unit that controls the display of the display unit in accordance with the position information detected by the display unit position detection unit, wherein the control unit changes the display of the set value so as to display the set value on the exposed range that is remaining when the display unit is shifted in the retraction direction.

Another aspect of the present invention provides a switching object switching apparatus that switches a switching object, the switching apparatus comprising: a console operated for switching the switching object; a setting operation member provided on the console and operated for changing the set value of the effect setting of the switching object; a display unit that displays the set value corresponding to the operation of the setting operation member; a shift mechanism that shifts the display unit in a predetermined retraction direction in which the exposed range of the display unit is reduced; a display unit position detection unit that detects the position of the display unit in the retraction direction; and a control unit that controls the display of the display unit in accordance with the position information detected by the display unit position detection unit, wherein the control unit changes the display of the set value so as to display the set value on the exposed range that is remaining when the display unit is shifted in the retraction direction.

Another aspect of the present invention provides a switching object switching apparatus that switches a switching object, the switching apparatus comprising: a console operated for switching the switching object; a display unit that is used for the effect setting of the switching object and that displays the set value of the effect setting; a shift mechanism that shifts the display unit in a predetermined retraction direction in which the exposed range of the display unit is reduced; a display unit position detection unit that detects the position of the display unit in the retraction direction; and a control unit that controls the display of the display unit in accordance with the position information detected by the display unit position detection unit, wherein the control unit displays the set value on the exposed range that is remaining when the display unit is shifted in the retraction direction.

Another aspect of the present invention provides a display control method in a video switcher comprising a console operated for switching a video and a display unit that is used for setting the video effect and that displays the set value of the video effect, the display control method comprising: as the display unit is shifted in a predetermined retraction direction in which the exposed range of the display unit is reduced, detecting the position of the display unit in the retraction direction; and controlling the display of the display unit in accordance with the detected position information for changing the display of the set value so as to display the set value on the exposed range that is remaining when the display unit is shifted in the retraction direction.

Another aspect of the present invention provides a display control method in a switching object switching apparatus comprising a console operated for switching a switching object and a display unit that is used for the effect setting of the switching object and that displays the set value of the effect setting, the display control method comprising: as the display unit is shifted in a predetermined retraction direction in which the exposed range of the display unit is reduced, detecting the position of the display unit in the retraction direction; and controlling the display of the display unit in accordance with the detected position information for changing the display of the set value so as to display the set value on the exposed range that is remaining when the display unit is shifted in the retraction direction.

As will be described bellow, the present invention includes other aspects. Therefore, the disclosure of the invention is intended to provide part of the aspects of the present invention and is not intended to limit the scope of the invention described and claimed herein.

### BRIEF DESCRIPTION OF THE DRAWINGS

FIG. 1 is a plan view of a video switcher according to an embodiment of the present invention;

FIG. 2 schematically depicts a configuration of the video switcher along with the display on the display unit;

FIG. 3A is a side view of the video switcher in which a display unit is in a first-stage position;

FIG. 3B is a side view of the video switcher in which the display unit is in a second-stage position;

FIG. 3C is a side view of the video switcher in which the display unit is in a third-stage position;

FIG. 4A is a plan view of the video switcher in which the display unit is in the first-stage position;

FIG. 4B is a plan view of the video switcher in which the display unit is in the second-stage position;

FIG. 4C is a plan view of the video switcher in which the display unit is in the third-stage position;

FIG. 5 is a block diagram of the video switcher according to the embodiment of the present invention;

FIG. 6 depicts a conventional video switcher;

FIG. 7 depicts the conventional video switcher; and

FIG. 8 depicts the conventional video switcher.

### DESCRIPTION OF SYMBOLS

11 video switcher
13 console
15 button group
17 display unit
19 setting operation unit
21 knob
25 display area
27 divided area
31 first divided image
32 second divided image
33 set value image
41 shift mechanism
51 control unit
53 display unit position detection unit

### BEST MODE FOR CARRYING OUT THE INVENTION

The present invention will now be described in detail. However, the following detailed description and the appended drawings do not limit the invention. Instead, the scope of the invention is defined by the appended claims.

A video switcher of the present invention comprises: a console operated for switching a video; setting operation members arranged on the console and operated for changing the set values of the video effects; a display unit that displays the set values corresponding to the operation of the setting operation members; a shift mechanism that shifts the display unit in a predetermined retraction direction in which the exposed range of the display unit is reduced; a display unit position detection unit that detects the position of the display unit in the retraction direction; and a control unit that controls the display of the display unit in accordance with the position information detected by the display unit position detection unit, wherein the control unit changes the display of the set values so as to display the set values on the exposed range that is remaining when the display unit is shifted in the retraction direction.

In this configuration, the display unit is movable in the retraction direction, and the movement enables to prevent being distracted by the display unit during a program. The setting operation members such as knobs are provided on the console, and therefore, the operation members are operable even if the display unit is shifted. Even if the display unit is shifted and the exposed range is reduced, the display of the set values is controlled such that the set values are displayed on the remaining exposed range. As a result, the present invention can provide a video switcher which enables to perform setting operation while checking the set values without being distracted by the display unit even during a program.

As described, in the present invention, the display unit for setting the video effects is movable in the retraction direction, the setting operation members are arranged on the console, and the display of the set values is changed in accordance with the shift of the display unit in the retraction direction. Therefore, the present invention can provide a video switcher which enables to perform setting operation while checking the set values without being distracted by the display unit even during a program.

The control unit may change the display position of the set values on the display unit in the opposite direction of the retraction direction when the display unit is shifted in the retraction direction.

With this configuration, even if the display unit is shifted in the retraction direction, the display of the set values can be left on the partially remaining exposed range by shifting the display of the set values in the opposite direction of the retraction direction.

The shift mechanism may be configured so as to move the display unit from a completely exposed position in which the entire display area is exposed to a partially exposed position in which part of the display area is exposed. The control unit may display the set values at the edge in the retraction direction of the display area when the display unit is in the completely exposed position and may display the set values at the edge in the retraction direction on the exposed range of the display area when the display unit is in the partially exposed position.

With this configuration, the set values are displayed at the edge in the retraction direction within the exposed range when the entire display area of the display unit is exposed as well as when part of the display area is exposed. The display position of the set values can be maintained even if the position of the display unit is changed, thereby facilitating the visual check of the set values and allowing the setting operation in the same manner.

The display unit may display a plurality of divided images on a plurality of divided areas in which the display area is divided, respectively, and the plurality of divided images may include a set value image that displays the set values. The control unit may change the alignment or order of the plurality of divided images in accordance with the position information of the display unit to shift the display position of the set value image.

With this configuration, the display position of the set values can be suitably changed. In this configuration, the shift mechanism may be configured such that the display unit shifts in the retraction direction in stages for shift lengths corresponding to the widths of the divided images in the retraction direction. The divided images may be realigned in conjunction with the shift of the display unit. In the display position with one divided image remaining on the exposed range, the set value image may be arranged on the exposed range. This enables to leave the display of the set values while minimizing the exposure of the display unit.

The setting operation members may be arranged adjacent to the edge in the retraction direction of the display unit when the entire display area of the display unit is exposed. With this configuration, the display of the set values and the setting operating members can be approximated, thereby facilitating the operation while checking the set values.

In another aspect of the present invention, the configuration of the video switcher is not limited to the configuration as described above in which the setting operation members are arranged on the console. A setting operation unit may be arranged on the display unit, and the setting operation may be performed using the display unit. For example, the display unit is a touch panel, and the touch panel functions as the setting operation unit. In this aspect too, the display of the set values is changed in accordance with the shift of the display unit, thereby preventing the display of the set values from hiding and allowing the setting operation even during a program. In the case utilizing a touch panel, the setting operation unit is also preferably changed in accordance with the display position. Typically, the position of the setting operation unit (button or the like) is shifted in the opposite direction on the display unit in response to the shift of the display unit.

Another aspect of the present invention provides a switching object switching apparatus that switches a switching object. In this aspect, the switching object is not limited to videos. The present invention can be suitably applied to a switching device comprising a display unit that displays the set values. The switching object may be sound, and in that case, the switching apparatus is an audio switching apparatus. In other words, the present invention is applied to an audio switching apparatus. The audio switching apparatus may be an audio control console called a mixer. The switching object may be lights, and in that case, the switching object switching apparatus is a lighting switching apparatus. In other words, the present invention is applied to a light switching apparatus. The light switching apparatus may be a light control console that switches the light control. Furthermore, the switching object may be a plurality of objects. For example, the switching object switching apparatus may switch videos and sound.

In this aspect, an advantage of the present invention can be obtained without limiting the switching object. More specifically, the display unit is movable in the retraction direction, and the shifting enables to prevent being distracted by the display unit. The setting operation members such as knobs are arranged on the console, and thus, the operation members are operable even if the display unit is shifted. Furthermore, the display of the set values is controlled so that the set values are displayed on the remaining exposed range even if the display unit is shifted and the exposed range is reduced. In this way, the present invention can also be suitably applied to any switching apparatus provided with a display unit that displays the set values of sound effects, light control or the like. The present invention can provide a switching object switching apparatus that enables to perform setting operation while checking the set values without being distracted by the display unit.

In another aspect of the present invention, the switching object is not limited to videos, and for example, the switching object may be sound or lights. The configuration of this aspect is not limited to the one in which the setting operation members are arranged on the console as described in the above configuration. In this aspect too, an advantage of the present invention described above can be obtained in the same way without these limitations.

Hereinafter, the video switcher according to an embodiment of the present invention will be described with reference to the drawings.

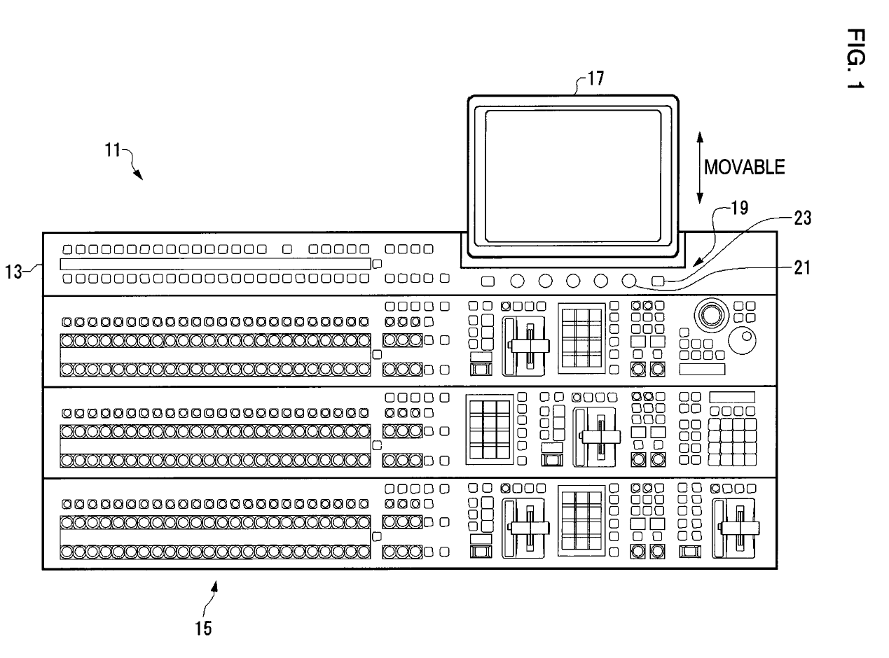

FIG. 1 shows the video switcher (video switching apparatus) according to the embodiment of the present invention. In FIG. 1, a video switcher 11 comprises a console 13, and a button group 15 for switching the videos is arranged on the console 13. A display unit 17 is provided at the rear edge of the console 13. Although the display unit 17 is depicted as being laid flat in FIG. 1 to facilitate understanding, the display unit 17 is actually placed upright. As described, the display unit 17 is constructed by a flat panel display, which is called a menu display panel, and is used for setting details of the video effects.

The console 13 comprises a setting operation unit 19 near the display unit 17. The setting operation unit 19 is constituted by setting operation members for changing the set values of the video effects using the display unit 17. In the present embodiment, the setting operation members are not integrated with the display unit 17, but instead, arranged on the console 13. In the present embodiment, the knobs 21 and the buttons 23 are provided as the operation members, which are adjacently aligned side by side. In the following description, the present invention will be described with the knobs 21 as a primary example of the setting operation members.

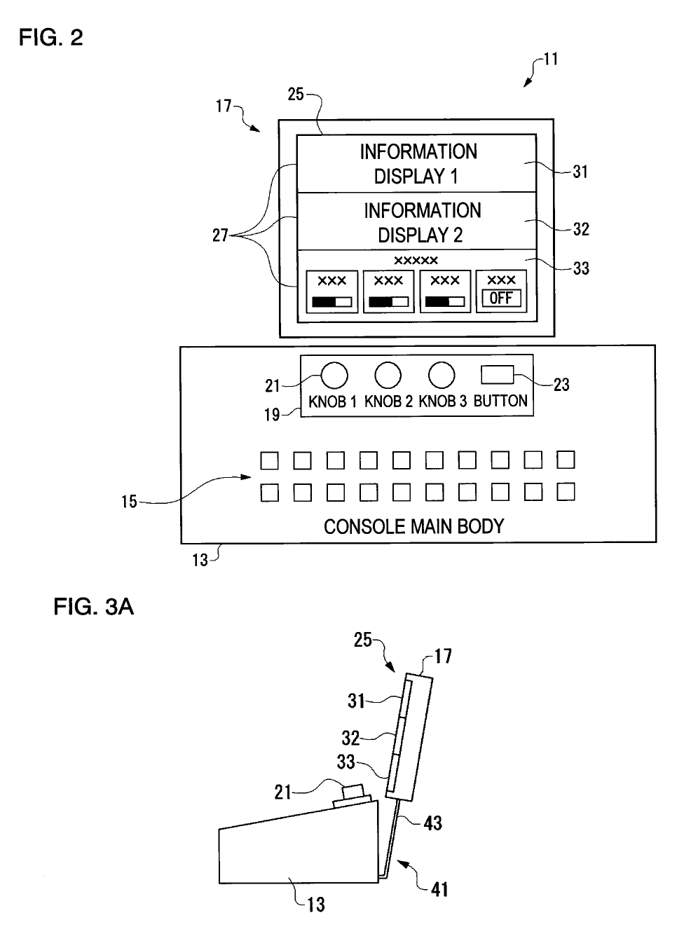

FIG. 2 schematically depicts the video switcher 11 along with the display on the display unit. The knobs 21 are arranged near the rear edge of the console 13 and are located in front of the display unit 17. The display unit 17 displays the set values at the lower edge, near the knobs 21. The set values of the knobs 21 are displayed to be located near the respective knobs 21. As the operator rotates the knob 21, the set value is changed in accordance with the rotation angle, and the change in the set value is reflected on the display on the display unit.

Further describing the display on the display unit in FIG. 2, in the present embodiment, a display area 25 of the display unit 17 is divided into a plurality of divided areas 27 (physically one screen, but a composite image consisted of a plurality of areas is displayed). In the example of FIG. 2, the number of the divided areas 27 is three (upper, middle, and lower), which are aligned vertically. Three divided images are displayed on the three divided areas 27 respectively. Each of the divided images is some kind of an information display image that is presented using the display unit 17. In the example of FIG. 2, three divided images denote a first divided image 31, a second divided image 32, and a set value image 33 (equivalent to a third divided image). The set value image 33 is an image of the set values that is set up using the knobs 21. According to the condition in FIG. 2, the first divided image 31 is displayed on the upper stage (first stage) of the divided areas 27, the second divided image 32 is displayed on the middle stage (second stage) of the divided areas 27, and the set value image 33 is displayed on the lower stage (third stage) of the divided areas 27. Since the set value image 33 is displayed near the knobs 21, the operator can easily figure out the functions of the knobs 21 and the set values.

In the present embodiment, the display unit 17 is movable up and down as described below. The plurality of divided images are realigned in accordance with the shift of the display unit 17, changing the display position of the set values.

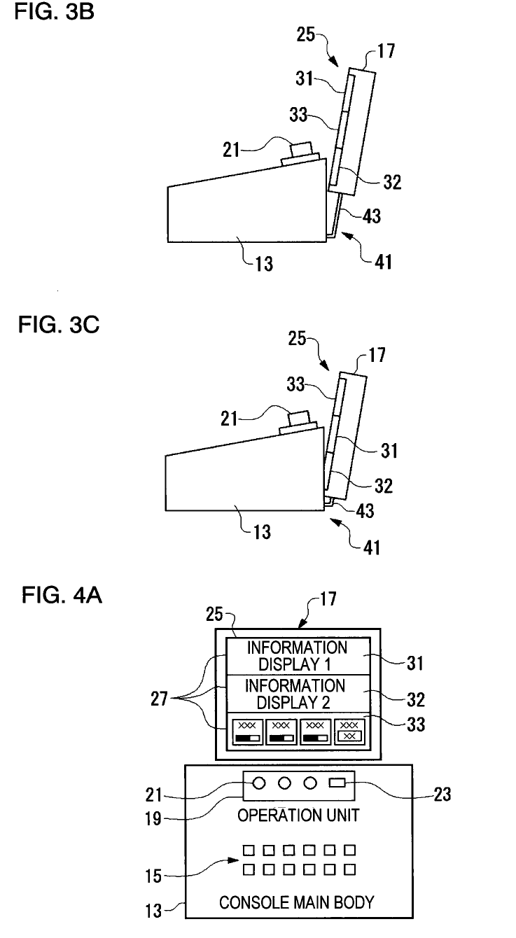

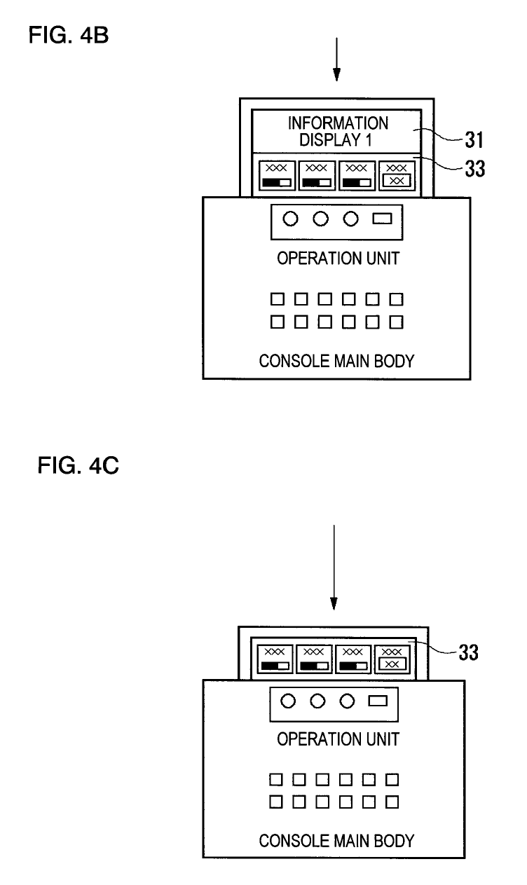

FIGS. 3A to 3C and FIGS. 4A to 4C depict an example of a shift mechanism 41 of the display unit 17. As shown in Figures, a pillar 43 is set up behind the main body of the console 13. The display unit 17 is slidable up and down along the pillar 43, causing the display unit 17 to slide up and down. In the present embodiment, the height of the display unit 17 is adjustable in three stages.

As shown in FIGS. 3A and 4A, in the first stage, the display unit 17 is in the highest position, and the entire display area 25 of the display unit 17 is exposed above the upper surface of the console 13. That is, the entire display area 25 is in sight of the operator.

As shown in FIGS. 3B and 4B, the display unit 17 is slightly shifted downward in the second stage. In this case, part of the display area 25 cannot be seen, hidden behind the console 13, and the remaining part is exposed. Specifically, one third of the display area 25 is hidden, and two thirds is exposed. The operator can see two divided areas 27 (upper stage and middle stage).

As shown in FIGS. 3C and 4C, the display unit 17 is shifted further downward in the third stage. In this case too, part of the display area 25 cannot be seen, hidden behind the console 13, and the remaining part is exposed. However, the exposed part is reduced. Specifically, two thirds of the display area 25 is hidden, while one third is exposed. The operator can see only one divided area 27 (upper stage).

The shift mechanism 41 comprises an engagement structure for fixing the display unit 17 at the positions of the three stages. When shifting the display unit 17, the operator releases the engagement. The display unit 17 is moved manually and then engaged again.

The up and down direction described above is a direction that reduces the exposed range of the display unit 17, which is equivalent to the retraction direction of the present invention. The display position of the first stage is a position in which the entire display area 25 is exposed, the position being equivalent to the completely exposed position of the present invention. The display positions of the second stage and the third stage are positions in which part of the display area 25 is exposed and, the positions being equivalent to the partially exposed positions of the present invention.

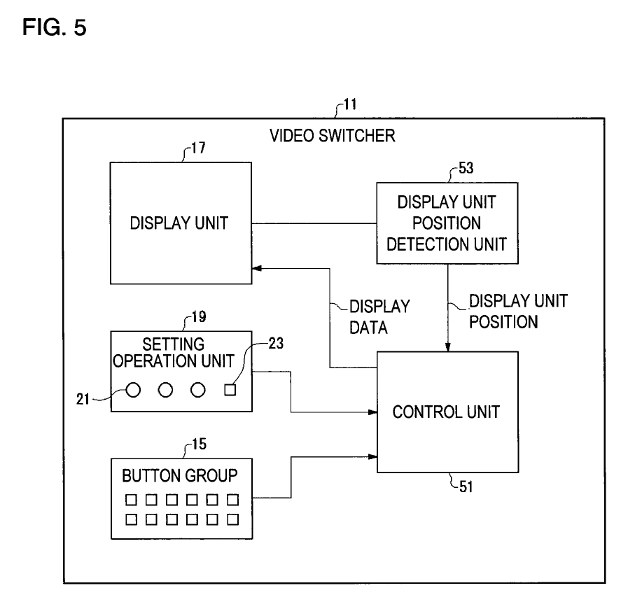

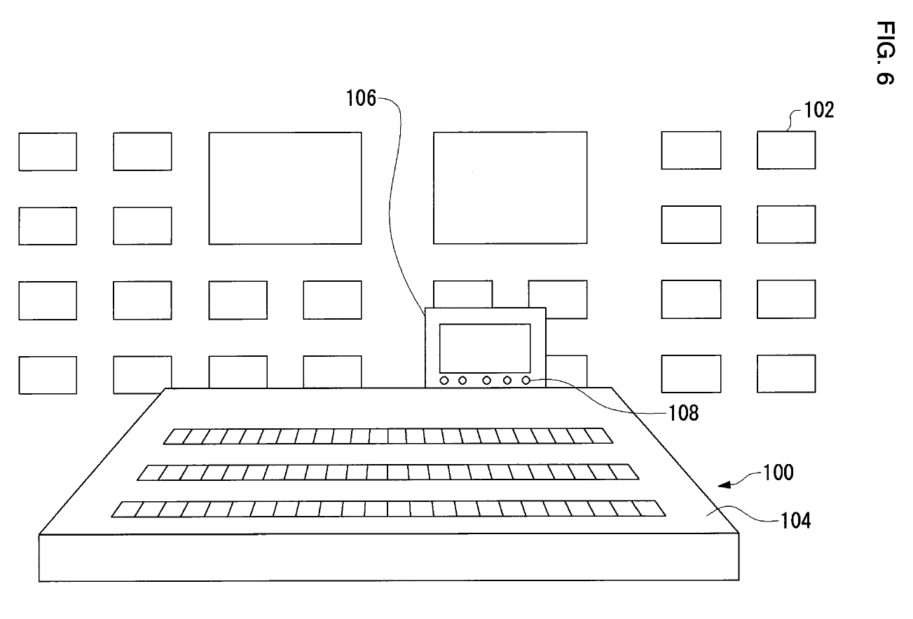

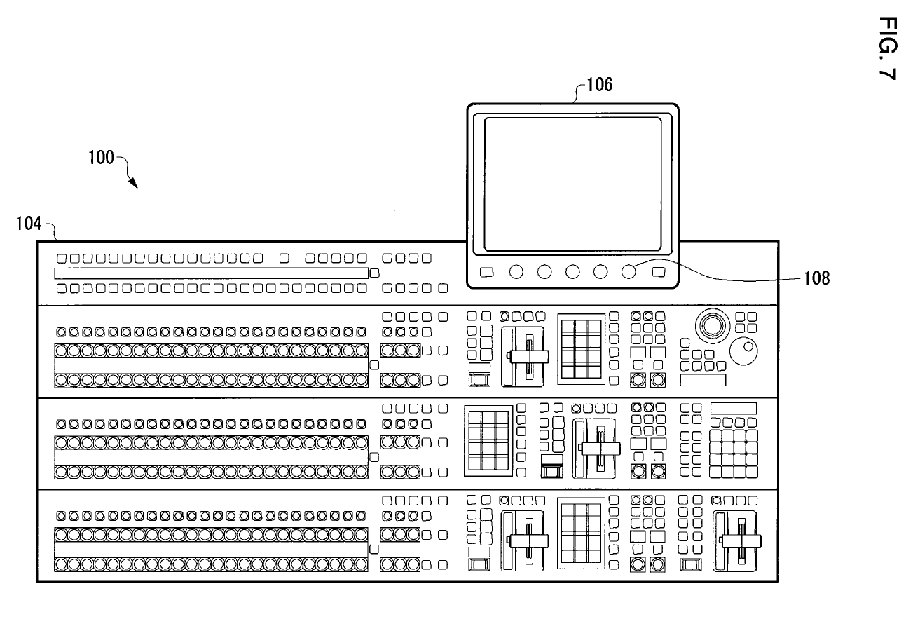

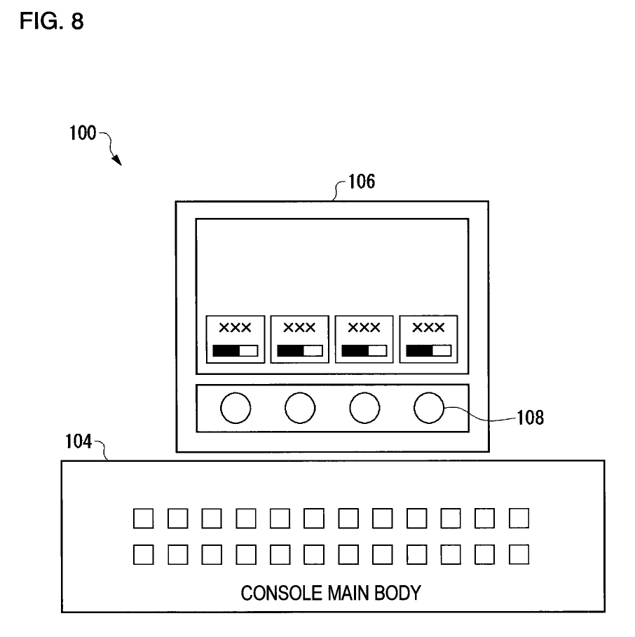

With reference to FIG. 5, a configuration for controlling the display of the display unit 17 will now be described along with a configuration of the video switcher 11. As described above, the video switcher 11 comprises the button group 15, the display unit 17, and the setting operation unit 19. The setting operation unit 19 comprises the plurality of knobs 21. The video switcher 11 further comprises a control unit 51 and a display unit position detection unit 53. The control unit 51 is a computer constructed by a CPU and so forth and controls the entire video switcher 11 including the configuration shown in FIG. 5.

A button operation signal is inputted to the control unit 51 from the button group 15. The control unit 51 responds to the button operation signal and switches the video in accordance with the button operation.

The setting operation unit 19 inputs a rotation operation signal of the knobs 21 to the control unit 51. In the present embodiment, an encoder is provided in each knob 21. The encoder detects the rotation angle of the knob 21, and the rotation angle is transmitted to the control unit 51 as a rotation operation signal. The control unit 51 changes the set value in accordance with the rotation angle of the knob 21.

The control unit 51, having an image processing function, generates display data of the display unit 17 and transmits the display data to the display unit 17. The display unit 17 displays the display data provided by the control unit 51. Having changed the set value in accordance with the operation of the knob 21, the control unit 51 transmits the display data, reflecting the set value after the change, to the display unit 17 and causes the display unit 17 to display the display data.

As described with reference to FIG. 2, the display unit 17 displays a composite image of three divided images (31 to 33) in the present embodiment. The control unit 51 generates display data in which these three divided images are composed and transmits the display data of the composite image to the display unit 17.

The display unit position detection unit 53 detects the position of the display unit 17 in the up and down direction. As described above, the height of the display unit 17 is adjusted in three stages in the present embodiment. The display position detection unit 53 is installed in the shift mechanism 41 and detects which of the three positions the display unit 17 is located. The display unit position detection unit 53 is constituted by, for example, three switches corresponding to three display positions respectively. The display position is detected by switching on and off.

The display unit position detection unit 53 reports the display position to the control unit 51. The control unit 51 realigns three divided images in accordance with the display position and causes the display unit 17 to display the display data of the images after the realignment, thereby changing the position of the set value image 33.

This completes the description of the configuration of the individual parts in FIG. 5. The operation of the video switcher 11 according to the present embodiment will now be described.

The detail setting with the display unit 17 is often conducted in the preparatory stages of the programs. At that point, the display unit 17 is suitably arranged at the position of the first stage, the highest stage, as shown in FIG. 3A and FIG. 4A. The display unit position detection unit 53 detects the display position and inputs the display position into the control unit 51. The control unit 51 controls the arrangement of the divided images in accordance with the display position. When the display unit 17 is at the position of the first stage, three divided images are arranged as shown in FIGS. 3A and 4A. Specifically, the first divided image and the second divided image 32 are respectively arranged in the upper stage and the middle stage of the divided areas 27. The set value image 33 corresponding to the knobs 21 is arranged in the lower stage of the divided areas 27.

The operator rotates the knobs 21 while looking at the set value image 33 to adjust the set values. Since the knobs 21 and the set value images 33 are close, the set values of the knobs 21 can be easily checked, and the adjustment is also easy.

When the preparation for a program is completed, the display unit 17 is retracted downward so as not to distract the video switching operation during the program. The height of the display unit 17 is adjusted as necessary.

In the example in FIG. 3B and FIG. 4B, the display unit 17 is at the position of the second stage, and two thirds of the display area 25 of the display unit is exposed. The display unit position detection unit detects the display position and inputs the display position into the control unit 51.

The control unit 51 realigns the divided images in accordance with the display position. When the display position of the second stage is detected, the control unit 51 changes the display position of the set value image 33 to the next higher stage of the divided areas 27. That is, the set value image 33 is displayed in the middle stage. The second divided image 32 is transferred from the middle stage of the divided areas 27 to the lower stage of the divided areas 27. The display of the first divided image 31 of the upper stage is maintained. As a result of the realignment, the set value image 33 is located at the lower edge of the exposed range of the display area 25. The positional relationship between the knobs 21 and the set value image 33 is maintained before and after the shifting of the display unit 17. Having shifted to the lowest stage, the second divided image 32 is invisible, hidden behind the main body of the console 13.

In the example of FIG. 3C and FIG. 4C, the display unit 17 is further lowered and is at the position of the third stage. One third of the display area 25 of the display unit 17 is exposed. When this display position is detected, the control unit 51 further realigns the divided images. In this case, the control unit 51 shifts the display position of the set value image 33 to the upper stage of the divided areas 27. The first divided image 31 that has been in the uppermost stage is shifted to the middle stage of the divided areas 27.

As the display unit 17 is lowered in the above operation, only the divided area 27 in the upper stage remains on the console 13. The set value image 33 has been shifted to the upper stage of the divided areas 27. In this case too, the set value image 33 is located at the lower edge of the exposed range of the display area 25, and the positional relationship between the knobs 21 and the set value image 33 is maintained. Other two divided images (first divided image 31 and the second divided image 32) are invisible, hidden behind the main body of the console 13.

Basically, the setting operation using the display unit 17 is not performed during a program. In the present embodiment, the display unit 17 is lowered downward and hidden behind the console 13, thereby preventing the display unit 17 from distracting monitoring and so forth.

However, there may be a sudden request for changing the setting during a program. In such a case, the knobs are arranged on the console 13 and are not hidden in the present embodiment. Furthermore, the set value image is displayed on the partially remaining display area, and the operator can figure out the set values. Therefore, the operator can handle the sudden setting request and promptly operate and adjust the knobs 21 while checking the current set values.

The video switcher 11 according to the embodiment of the present invention has been described above. According to the present embodiment, the display unit 17 is movable in the retraction direction (up and down direction in the example above), and the moving or shifting enables to prevent being distracted by the display unit 17 during a program. The knobs 21 serving as the setting operation members are provided on the console 13, and thus, the operation members are still operable even if the display unit 17 is shifted. Furthermore, even if the display unit 17 is shifted and the exposed range is reduced, the display of the set values is controlled so as to display the set values on the remaining exposed range. As a result, the setting operation can be performed while checking the set values without being distracted by the display unit 17 during a program.

According to the present embodiment, even if the display unit 17 is shifted in the retraction direction, the display of the set values can be left on the partially remaining exposed range by shifting the display in the opposite direction of the retraction direction.

According to the present embodiment, the display unit is shifted from the completely exposed position (first-stage position) to the partially exposed positions (second-stage position and third-stage position). The control unit 51 displays the set values at the edge in the retraction direction of the display area 25 when the display unit 17 is at the completely exposed position and displays the set values at the edge in the retraction direction of the exposed range of the display area 25 when the display unit 17 is at the partially exposed position. In this way, the set values are displayed at the edge in the retraction direction within the exposed range when the entire display area 25 is exposed as well as when part of the display area 25 is exposed. The display position of the set values can be maintained even when the position of the display unit is changed. In the example above, the positional relationship between the knobs 21 and the display of the set values is maintained. Therefore, visual check of the set values is facilitated regardless of the position of the display unit 17, and the setting operation can be performed in the same manner.

According to the present embodiment, the display unit 17 displays a plurality of divided images on the plurality of divided areas 27, respectively, and a set value image 33 is included in the plurality of divided images. The control unit 51 changes the alignment of the divided images in accordance with the position information of the display unit 17. This enables to suitably change the display position of the set values.

In the above example, the shift mechanism is configured such that the display unit 17 shifts in stages for shift lengths corresponding to the widths of the divided images in the retraction direction. The divided images are realigned in conjunction with the shift of the display unit 17. Particularly, in the display position in which one divided image remains on the exposed range, the set value image remains on the exposed range. This enables to leave the display of the set values while minimizing the exposure of the display unit 17.

In the present embodiment, the setting operation members are arranged adjacent to the edge in the retraction direction of the display unit 17 at the time in which the entire display area 25 of the display unit is exposed. With this configuration, the display of the set values and the setting operating members can be approximated, thereby facilitating the operation while checking the set values.

A modification example of the above embodiment will now be described. In the above embodiment, the display unit 17 is manually shifted. However, the display unit may be mechanically shifted within the scope of the present invention. For example, the display unit 17 may be shifted with motor power. In that case, a motor control circuit determines the rotation angle of the motor and controls the motor so as to accomplish the rotation angle determined value. The motor control circuit may report the rotation angle determined value to the control unit 51 to thereby function as the display unit position detection unit 53. Alternatively, the display position may be detected by a sensor. The motor rotation angle may be detected by an encoder or the like, and the display position may be calculated from the motor rotation angle.

In the above embodiment, the knobs 21 have been primarily described as the setting operation members. However, the setting operation members are not limited to the knobs 21. For example, as described, the buttons 23 shown in FIG. 1 and FIG. 2 are also a setting operation members. As shown in FIG. 4, the set value display (on or off) using the button 23 is controlled in accordance with the display position, in the same way as the set value display using the knobs 21. Other types of operation members can also serve as the setting operation members.

In the above embodiment, the position of the display unit 17 is adjusted in stages. However, the position of the display unit 17 may be adjusted continuously without any particular stage. In that case, the display position of the set values is also preferably adjusted without any stage.

In the above embodiment, the display position of the set values is changed by realigning the divided images. However, the display position may be changed with other processes within the scope of the present invention. For example, the screen may be scrolled.

In the above embodiment, information is also displayed on the part hidden behind the console 13. Alternatively, the display may be blank or the like without displaying the information on the part hidden behind the console 13.

In the above embodiment, the knobs 21 may be multi-functional. In that case, each knob 21 corresponds to a plurality of kinds of set values. When a function of the knobs 21 is changed, the display of the set values is changed accordingly. It is obvious that the display unit can display images other than the above described images within the scope of the present invention. It is also obvious that the display unit 17 can display images other than the three divided images in the example above.

In the present embodiment, the display of the set values is shifted to perform the display changing process for leaving the display of the set values on the exposed range of the display area 25. However, the set values may be left on the exposed range with a display changing process other than the shifting. For example, the display may be transformed. The display transformation process may be combined with the display shifting process which has been described above.

One example of the display transformation includes compressing. For example, the aspect ratio of the image is changed. When the display unit 17 is lowered, the dimension in the vertical direction is contracted, and the image is arranged within the exposed range. As a simple example, the aspect ratio of the image may be changed from “4:3” to “16:9”.

In another example of the display transformation, the display of the set values is changed from graphics (figures) to texts when the display unit 17 is lowered. For example, the values of the set values are displayed with numbers. This enables to contract the size of the display and leave the display of the set values on the exposed range.

In the present embodiment, the display unit 17 is shifted up and down. However, the display unit 17 may be shifted in other directions within the scope of the present invention. That is, the retraction direction of the present invention is not limited to the up and down direction.

In the present embodiment, the display unit 17 is hidden behind the console 13. However, the present invention is not limited to this. For example, the display unit 17 may be housed in the console 13.

In the present embodiment, the setting operation unit and the operation members thereof are arranged on the console 13. However, a configuration in which the setting operation unit is not arranged on the console 13 is feasible. For example, the setting operation unit is arranged on the display unit 17. Typically, the display unit 17 is a touch panel, and the touch panel functions as the setting operation unit. In this case, the setting operation unit on the touch panel is suitably arranged near the display of the set values. Preferably, the setting operation unit is also changed on the display unit 17 in accordance with the position of the display unit 17. Preferably, the position of the setting operation unit (button or the like) is shifted in the opposite direction on the display unit 17 in accordance with the shift of the display unit 17. This enables to avoid the hiding of the setting operation unit. That is, the exposure can be maintained. Even with such a configuration, the setting operation can be performed while checking the set values during a program.

In the present embodiment, the display unit 17 is a general flat panel display. However, a bendable, flexible display unit may also be applied. This configuration is advantageous when the console 13 is thin-type. The display unit may be bent and partially housed under the console 13. In that case too, the set values are suitably displayed on the display area remaining on the console 13.

The present embodiment provides a video switcher, and the switching object is a video. It can be said that the video switcher is one example of a switching object switching apparatus. In another example, the switching object switching apparatus is an audio switching apparatus, i.e. an audio control console called a mixer, in which the switching object is sound. In another example, the switching object switching apparatus is a light switching apparatus in which the switching object is lights or the like. That is, the switching object switching apparatus is a light control console that adjusts the light control of lights or the like. As described, the switching object is not limited to videos. The present invention can be suitably applied even when switching sound, light control, or the like, as long as the display unit that displays the set values of sound effects, light control, or the like is provided. An advantage of the present invention can be obtained in a similar way. The setting operation can be performed while checking the set values without being distracted by the display unit during a program or an event. It is obvious that a plurality of kinds of switching objects may also be employed within the scope of the present invention. For example, videos and sound may be switched by the console.

Although the preferred embodiments of the present invention conceivable at this point have been described, it is to be understood that various modifications can be made to the embodiments, and it is intended that the appended claims include all such modifications within the true spirit and the scope of the present invention.

### INDUSTRIAL APPLICABILITY

As described, the video switcher of the present invention is advantageous in that the setting operation can be performed while checking the set values without being distracted by the display unit even during a program, and is useful as a switcher or the like for producing programs.

1. A video switcher comprising:
a console operated for switching a video;
a setting operation member provided on the console and operated for changing a set value of a video effect;
a display unit for displaying the set value corresponding to the operation of the setting operation member;
a shift mechanism for shifting the display unit in a predetermined retraction direction in which an exposed range of the display unit is reduced;
a display unit position detection unit for detecting a position of the display unit in the retraction direction; and
a control unit that controls displaying by the display unit in accordance with the position information detected by the display unit position detection unit, wherein
the control unit changes the display of the set value so as to display the set value on the exposed range that is remaining when the display unit is shifted in the retraction direction.

2. The video switcher according to claim 1, wherein the control unit changes the display position of the set value on the display unit in the opposite direction of the retraction direction when the display unit is shifted in the retraction direction.

3. The video switcher according to claim 2, wherein the shift mechanism is configured so as to shift the display unit from a completely exposed position in which the entire display area is exposed to a partially exposed position in which part of the display area is exposed, and
the control unit displays the set value at the edge in the retraction direction of the display area when the display unit is at the completely exposed position and displays the set value at the edge in the retraction direction of the exposed range of the display area when the display unit is at the partially exposed position.

4. The video switcher according to claim 1, wherein the display unit displays a plurality of divided images on a plurality of divided areas in which the display area is divided, respectively, the plurality of divided images including a set value image for displaying the set value, and
the control unit changes the alignment of the plurality of divided images in accordance with the position information of the display unit to shift the display position of the set value image.

5. The video switcher according to claim 1, wherein the setting operation member is arranged adjacent to the edge in the retraction direction of the display unit when the entire display area of the display unit is exposed.

6. A video switcher comprising:
a console operated for switching a video;
a display unit that is used for setting a video effect and that displays a set value of the video effect;
a shift mechanism for shifting the display unit in a predetermined retraction direction in which an exposed range of the display unit is reduced;
a display unit position detection unit for detecting a position of the display unit in the retraction direction; and
a control unit that controls displaying by the display unit in accordance with the position information detected by the display unit position detection unit, wherein
the control unit changes the display of the set value so as to display the set value on the exposed range that is remaining when the display unit is shifted in the retraction direction.

7. A switching object switching apparatus for switching a switching object, the switching object switching apparatus comprising:
a console operated for switching the switching object;
a setting operation member provided on the console and operated for changing a set value of effect setting of the switching object;
a display unit for displaying the set value corresponding to the operation of the setting operation member;
a shift mechanism for shifting the display unit in a predetermined retraction direction in which an exposed range of the display unit is reduced;
a display unit position detection unit for detecting a position of the display unit in the retraction direction; and
a control unit that controls displaying by the display unit in accordance with the position information detected by the display unit position detection unit, wherein
the control unit changes the display of the set value so as to display the set value on the exposed range that is remaining when the display unit is shifted in the retraction direction.

8. A switching object switching apparatus for switching a switching object, the switching object switching apparatus comprising:
a console operated for switching the switching object;
a display unit that is used for effect setting of the switching object and that displays a set value of the effect setting;
a shift mechanism for shifting the display unit in a predetermined retraction direction in which an exposed range of the display unit is reduced;
a display unit position detection unit for detecting a position of the display unit in the retraction direction; and
a control unit that controls displaying by the display unit in accordance with the position information detected by the display unit position detection unit, wherein
the control unit changes the display of the set value so as to display the set value on the exposed range that is remaining when the display unit is shifted in the retraction direction.

9. A display control method in a video switcher comprising a console operated for switching a video and a display unit that is used for setting an video effect and that displays the set value of the video effect, the display control method comprising:
detecting, when the display unit is shifted in a predetermined retraction direction in which an exposed range of the display unit is reduced, a position of the display unit in the retraction direction; and
controlling displaying by the display unit in accordance with the detected position information for changing the display of the set value so as to display the set value on the exposed range that is remaining when the display unit is shifted in the retraction direction.

10. A display control method in a switching object switching apparatus comprising a console operated for switching a switching object and a display unit that is used for effect setting of the switching object and that displays a set value of the effect setting, the display control method comprising:
detecting, when the display unit is shifted in a predetermined retraction direction in which an exposed range of the display unit is reduced, a position of the display unit in the retraction direction; and
controlling displaying by the display unit in accordance with the detected position information for changing the display of the set value so as to display the set value on the exposed range that is remaining when the display unit is shifted in the retraction direction.
